(19) United States
(12) Patent Application Publication
(10) Pub. No.: US 2003/0149651 A1
(43) Pub. Date: Aug. 7, 2003

(54) Offshootfund investment process

(76) Inventors: John Charles Boyle, Edison, NJ (US); Brett Anthony Boyle, Edison, NJ (US)

Correspondence Address: John C Boyle, 639 Denver Boulevard, Edison, NY, 08820, US

(21) Appl. No.: 10/257,999

(22) PCT Filed: Feb. 21, 2001
(86) PCT No.: PCT/US01/40156

(51) Int. Cl. G06F 17/60

(52) U.S. Cl. 705/35

(57) ABSTRACT

A process for allowing an investor within the structure of a Crossfund to purchase simultaneously a separate fund which is specialized for purchasing future contracts and other options to hedge against currency movement during the rights exchange period of Crossfund is disclosed (see FIG. 3). The innovative process includes the establishment of the Offshootfund with the issuance of Crossfund. An investor owns 50% of each Offshootfund portfolio (32,28). One portfolio is dollar-denominated and the other is euro-denominated. The process illustrates how Offshootfund ownership is determined on a 50% basis an improvement over Crossfund calculations, where a single innovative exchange of rights is done. A sharing of risk this way provides a protection for the investor. The process permits the manager to purchase future contracts and option contracts against currency movements. At rights reversal of Crossfund, there is the calculation to determine settlement from either the dollar-denominated portfolio or the euro-denominated portfolio.

### CROSS-REFERENCE TO RELATED APPLICATIONS

Offshootfund an improvement on a previously granted U.S. Pat. No. 6,073,116, Crossfund Investment Process, issued on Jun. 6, 2000, to John C. Boyle.

### TECHNICAL FIELD

Offshootfund Investment Process is two separate currency hedge portfolios (eg. $ and [symbol] ) within a closed-end mutual fund structure, issued simultaneously in two international jurisdictions with investors owning 50% of the opposing portfolio with the objective of hedging currency movement for a fixed period to protect domestic portfolios issued under Crossfund Investment Process. The exemplary process allows an investor to be grouped with other investors to hedge against currency movement between the US dollar and euro for the fixed period. An investor owns 50% of the dollar side and euro side, which are initially equalized so that the manager can maintain a unique hedged position. Even if one portfolio goes to zero during the period, the other portfolio is still 50% owned, thus giving an investor a built-in hedge for managing currency movement during the period. It is anticipated that this Offshoot portfolio will work to protect the Crossfund portfolios. Programming for Crossfund and Offshootfund notice as provided for by law is made as follows: © 2000 and 2001 Brett A. Boyle.

### BACKGROUND OF THE INVENTION

There has been only one structure for international investing by mutual fund. The traditional international mutual fund takes an investors capital, then purchases currency from a bank to convert to the overseas currency from the domestic currency. Crossfund's exemplary process permits an investor to gain international portfolio diversification in a mutual fund for a fixed period with no initial, bank currency cost by its patented process.

The present invention allows an expanded process of Crossfund, whereby a new investment structure, Offshootfund, employs separate portfolios of the two domestic currencies to be used exclusively to hedge against currency fluctuation to protect the Crossfund portfolios. The manager establishes an Offshootfund structure within Crossfund investment process.

There are many hedge funds, but none are structured within a current international fund to protect two sides of an international investment. Offshootfund thus seeks for the first time to provide a benefit to the international investor by having a fixed portfolio structure seek to take positions to protect the principal, dual portfolios of one structure, Crossfund, a risk protection that current, standard international funds do not provide. While every international mutual fund faces a risk of currency movement during the investment period, including Crossfund, the present exemplary process seeks to offset this risk by investing in currency hedge strategies, such as options, future contracts, etc., during the fixed period of international diversification, within the closed-end structure so that an investor has the knowledge that a professional manager is seeking to protect the investment's portfolio.

### DISCLOSURE OF THE INVENTION

The advantage of the present invention as an improvement on Crossfund demonstrates how an international investor is protected from two major adverse factors: the cost to exchange currency, which is solved by Crossfund, and a hedge scheme to protect the investment from currency movement, a risk protection strategy solved by Offshootfund. In effect, the manager forms four separate portfolios, two of them in Crossfund and two of them in Offshootfund, under a closed system for a long term fixed period. The traditional, international mutual fund has two distinct flaws: high bank currency cost on both sides of the investment, and no risk protection from currency movement during the investment period. Crossfund and the improvement, Offshootfund, solve these two major adverse factors.

### BRIEF DESCRIPTION OF THE SEVERAL VIEWS OF THE DRAWING

With the improvement of Crossfund, the invention now takes into consideration the movement of currency rate for the investment period.

FIG. 1 illustrates the manager creating a Crossfund to obtain the final values at rights exchange for the innovative process.

FIG. 2 illustrates the manager creating a Offshootfund to obtain the final values at rights exchange for the innovative process.

FIG. 3 illustrates the manager using calculations of Crossfund and Offshootfund, adding these together, to compute final differential.

### DETAILED DESCRIPTION OF THE INVENTION

With traditional international mutual funds, an investor has no protection at all from currency movement. The improvement description following shows how currency movement risk is now factored into a Crossfund Investment Process with the addition of Offshootfund, as the following drawings clearly describe:

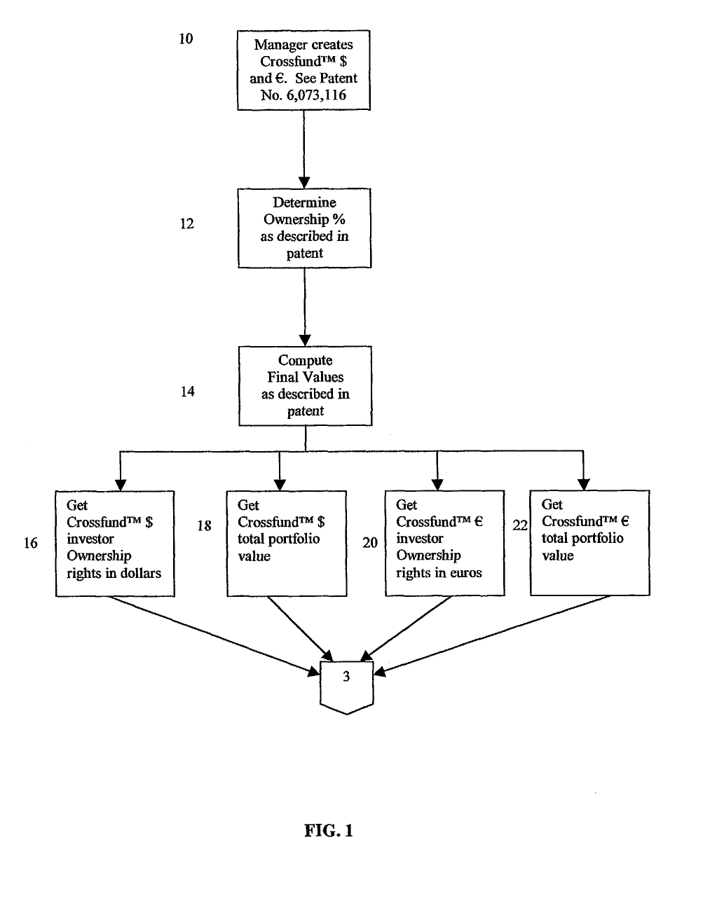

FIG. 1 begins the exemplary process by the Crossfund manager at 10 creating Crossfund, which is done as in the U.S. Pat. No. 6,073,116. At 12, manager determines ownership percentage, the same as in the patent. At 14, manager computes final values as described in the patent. At 16, manager gets Crossfund dollar-denominated investor ownership rights in dollars, as in the patent. At 18, manager gets Crossfund $ total portfolio value, as in the patent. At 20, manager gets Crossfund euro-denominated investor ownership rights in euros, as in the patent. At 22, manager gets Crossfund [symbol] total portfolio value, as in the patent.

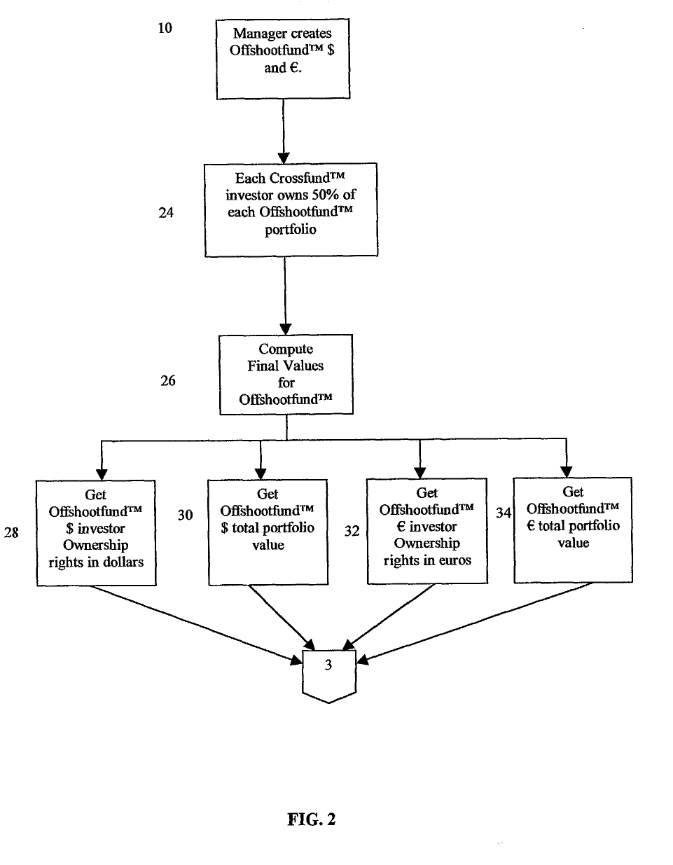

FIG. 2 continues the exemplary process with the manager, again position 10 to denote authority, creates the Offshootfund. By creating a dollar and euro denominated Offshootfimd portfolio, there is dedicated a fixed amount to hedge against currency movement between dollar and euro (or any two currencies, for example yen to pound). The manager creates two amounts that are equal based upon official currency rates of the two currencies to make up Offshootfund. As in the diagram box at 24, each investor now owns 50% of each denomination. The final values for Offshootfund are computed based upon the growth or loss of Offshootfund over the rights exchange period of time, as shown in the diagram as 26. The final rights of each investor are then determined based upon the final exchange rate, portfolio value and ownership percentage. At 28, manager gets Offshootfund dollar-denominated investor ownership rights in dollars. At 30, manager gets Offshootfund $ total portfolio value. At 32, manager gets Offshootfund™ euro-denominated investor ownership rights in euros. At 34, manager gets Offshootfund™ [symbol] total portfolio value.

An investor in Crossfund will now have Offshootfund to offset currency exposure, and will be using minimal bank currency cost, as compared to a traditional, international mutual fund, which has no structure to hedge against currency movement and a high bank cost on entry and exit for currency rate transactions in mutual funds. One investor under this exemplary process will not ever have a bank currency cost.

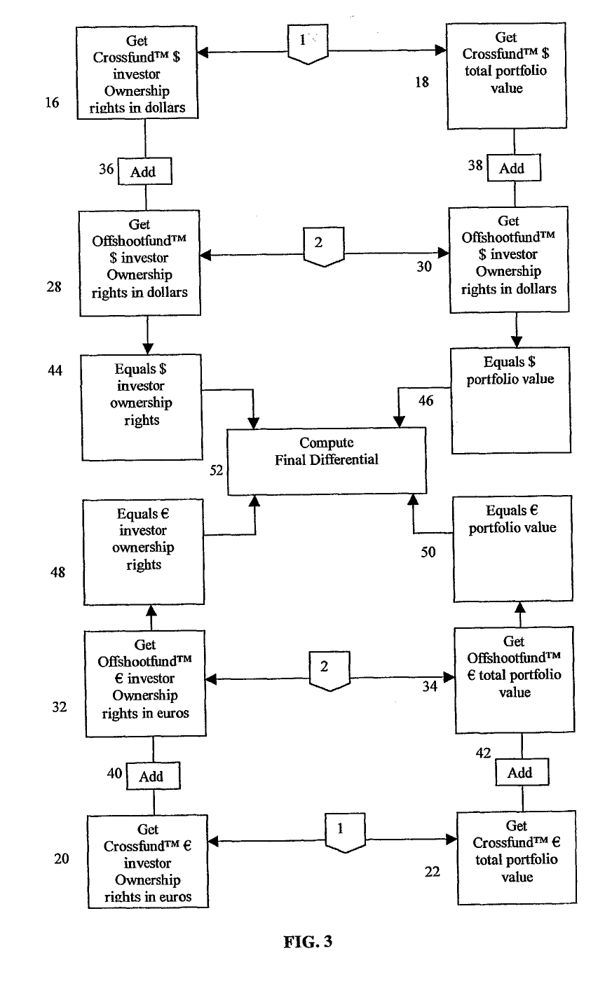

FIG. 3 continues the exemplary process by importing the values from FIG. 1 and FIG. 2. The values from 16 and 28 are added together (box 36 shows the addition) to arrive at a value in 44, which equals the dollar-denominated investors' ownership rights. The values from 18 and 30 are added together (box 38 shows the addition) to arrive at a value in 46, which equals the dollar portfolio value. The values from 20 and 32 are added together (box 40 shows the addition) to arrive at a value in 48, which equals the euro-denominated investors' ownership rights. The values from 22 and 34 are added together (box 42 shows the addition) to arrive at a value in 50, which equals the euro portfolio value.

The values from 44, 46, 48 and 50 are used to compute the final differential, as shown with box 52. And, the exemplary process shows that only one investor ever has to use a bank to convert currency, and this by only the differential value.

### BEST MODE FOR CARRYING OUT THE INVENTION

A computer program language, Borland C++, was used to perform the computer calculations in carrying out the exemplary process. Calculations can be used on any operating system and computer language, but displays best to investors in a Windows operating system. A Dell computer was used to run the program. Those skilled in the art will be able to perform calculations in any computer language to utilize their specific operating system of a hardware and software manufacturer.

What is claimed is:

1. An exemplary process using a computer to allow Crossfund mutual fund investors to have a fixed amount of capital targeted as a built-in hedge fund, Offshootfund, to seek to offset currency movement during the international fixed period of Crossfund investing.
